(19) United States
(12) Patent Application Publication
(10) Pub. No.: US 2026/0368442 A1
(43) Pub. Date: Nov. 19, 2026

(54) USER-DEFINED ALERT MONITORING FOR APPLICATION VIRTUAL ASSISTANT SYSTEMS AND APPLICATIONS

(71) Applicant: NVIDIA Corporation, Santa Clara, CA (US)

(72) Inventors: Vladimir Getselevich, Los Gatos, CA (US); Anjul Patney, Redmond, WA (US); Deep Shekhar, Bangalore (IN); Ram Rangan, Chennai (IN)

(21) Appl. No.: 19/210,498

(22) Filed: May 16, 2025

(51) Int. Cl. G06F 40/40; G06F 9/451

(52) U.S. Cl. CPC G06F 40/40; G06F 9/453

(57) ABSTRACT

In various examples, artificial intelligence-based (AI) assistants may create, monitor, and trigger user-defined alerts associated with interactive applications. For instance, responsive to an application user submitting a natural language request, such as “notify me when my inventory is full,” the systems and methods of the present disclosure may convert the request into a structured format that allows an AI assistant to dynamically monitor application state and alert the user when the condition is met. In some examples, this conversion may include using a language model to generate interpretable logic expressions (e.g., key-value comparisons), executable code functions, and/or additional language model calls associated with evaluating the application state in real time. When the application state indicates the condition is met, a corresponding alert may be triggered through one or more user interface mechanisms, such as visual highlights, popup messages, and/or auditory cues.

### BACKGROUND

Virtual assistants may be included in a wide variety of today's interactive applications to provide assistance and enhance user experience. For instance, gaming applications, productivity tools, creative environments, or any other types of interactive applications may rely on virtual assistants to monitor application state or user interactions and deliver contextual support, such as task recommendations, real-time tips, or status updates. To interpret user context, evaluate conditions, or respond appropriately to changes within the application, these virtual assistants may depend on access to dynamic application state. This state information may include elements such as object presence, user activity, system events, or resource levels, and may be obtained through exposed application programming interfaces (APIs) or inferred using techniques such as computer vision, object detection, and optical character recognition. By processing this data in real time, virtual assistants may enhance their ability to operate in contextually appropriate and situation-aware ways.

Despite these capabilities, however, conventional virtual assistants may be limited in scope and, oftentimes, constrained to responding to a fixed set of predefined conditions, inputs, or queries. For example, conventional virtual assistant systems may rely on static event mappings or hardcoded triggers defined by developers during application design. Such constraints may inhibit the virtual assistant's ability to adapt to novel scenarios, respond to evolving application states, or anticipate user needs beyond predefined boundaries. As a result, the level of support provided by virtual assistants may, in some instances, be insufficient and/or may not scale well across dynamic or highly interactive environments.

### SUMMARY

Embodiments of the present disclosure relate to user-defined alert monitoring for application virtual assistant systems and applications. Systems and methods are disclosed that may create, monitor, and trigger user-defined alerts associated with interactive applications, such as gaming applications, productivity tools, creative environments, and/or any other types of interactive applications.

For instance, responsive to a user of an application submitting a natural language request to create an alert, such as “notify me when my inventory is full” or “let me know when I have five minutes remaining,” the systems and methods of the present disclosure may convert the natural language request into a structured format that allows an AI assistant to dynamically monitor application state and alert the user when the condition is met. In some examples, this conversion may include using a language model to generate interpretable logic expressions (e.g., including key-value comparisons), executable code functions, and/or additional language model calls associated with evaluating the application state in real time. When the application state indicates the condition is met, a corresponding alert may be triggered through one or more user interface mechanisms, such as visual highlights, popup messages, and/or auditory signals.

In contrast to conventional systems, the systems and methods of the present disclosure, in some embodiments, may enable application users to define custom alerts using natural language, without requiring prior knowledge of the application's internal mechanics or programming expertise. For instance, by using language models to transform natural language alert specifications into structured logic expressions and/or executable functions for monitoring dynamic application state in real time, the systems and methods of the present disclosure may provide a flexible and scalable alerting framework capable of adapting to a wide range of user-defined conditions. Additionally, by supporting both lightweight logic-based evaluation and more complex compiled procedures, the disclosed systems and methods can accommodate alert conditions of varying complexity while maintaining efficient runtime performance. Further, in contrast to conventional systems that rely on fixed, developer-defined alert triggers or hardcoded event mappings, the systems of the present disclosure support alert specification and dynamic adaptation to evolving user needs and contextual scenarios at application runtime. As a result, the systems and methods of the present disclosure provide significant technical advantages in adaptability, personalization, and scalability, improving the responsiveness and contextual relevance of application virtual assistant systems across diverse application environments.

### BRIEF DESCRIPTION OF THE DRAWINGS

The present systems and methods for user-defined alert monitoring for application virtual assistant systems and applications are described in detail below with reference to the attached drawing figures, wherein:

FIG. 1 is a data flow diagram illustrating an example of a process for implementing user-defined alerts for an interactive application, in accordance with some embodiments of the present disclosure;

FIG. 2 illustrates examples of key-value pairs indicative of a state associated with an application, in accordance with some embodiments of the present disclosure;

FIG. 3 illustrates an example of converting a natural language request into logic for triggering a user-defined alert, in accordance with some embodiments of the present disclosure;

FIG. 4 is a block diagram illustrating an example of a system that may perform one or more of the processes, methods, or techniques of the present disclosure;

FIG. 5 is a flow diagram illustrating an example of a method for implementing user-defined alerts for an interactive application, in accordance with some embodiments of the present disclosure;

FIG. 6 is a flow diagram illustrating an example of a method for converting a natural language alert specification into logic conditions for triggering a user-defined alert associated with an application, in accordance with some embodiments of the present disclosure;

FIG. 7 is a block diagram of an example content streaming system suitable for use in implementing some embodiments of the present disclosure;

FIG. 8A is a block diagram of an example generative language model system suitable for use in implementing at least some embodiments of the present disclosure;

FIG. 8B is a block diagram of an example generative language model that includes a transformer encoder-decoder suitable for use in implementing at least some embodiments of the present disclosure;

FIG. 8C is a block diagram of an example generative language model that includes a decoder-only transformer architecture suitable for use in implementing at least some embodiments of the present disclosure;

FIG. 9 is a block diagram of an example computing device suitable for use in implementing at least some embodiments of the present disclosure; and

FIG. 10 is a block diagram of an example data center suitable for use in implementing at least some embodiments of the present disclosure.

### DETAILED DESCRIPTION

Systems and methods are disclosed related to user-defined alert monitoring for application virtual assistant systems and applications. More specifically, the disclosed systems and methods may be used to create, monitor, and trigger user-defined alerts associated with interactive applications, such as gaming applications, productivity tools, creative environments, and/or any other types of interactive applications. For instance, responsive to an application user submitting a natural language request to create an alert, such as “notify me when my inventory is full” or “let me know when I have five minutes remaining,” the systems and methods of the present disclosure may convert the natural language request into a structured format that allows an AI assistant to dynamically monitor application state and alert the user when the alert condition is met. In some examples, this conversion may include using a language model to generate interpretable logic expressions (e.g., key-value comparisons), executable code functions, and/or additional language model calls associated with evaluating the application state in real time. When the application state indicates the condition is met, a corresponding alert may be triggered through one or more user interface mechanisms, such as visual highlights, popup messages, and/or auditory signals.

In some examples, a system(s) may receive input data representative of an alert specification. That is, the alert specification may indicate a natural language request to issue an alert responsive to a condition or event associated with an interactive application. For example, a user may provide a natural language input such as “alert me when I have enough materials to build a ship” or “notify me when a blue dinosaur appears.” In some instances, the input data may include text data, audio data, image data, and/or a combination thereof. For instance, the input data may include text data representing typed or spoken text corresponding to the natural language expression, or audio data representing the natural language expression. Additionally, or alternatively, the input data may include audio data or image data representing visual, audio, or video content to further contextualize the request (e.g., a screenshot or image indicating a specific object to track). In various instances, the alert specification may be received during runtime of the application and processed asynchronously so as not to interrupt the user's ongoing interaction with the application or virtual assistant.

As described herein, the system(s) may apply the input data (e.g., the text data, audio data, image data, etc.) as input to one or more language models or other artificial intelligence (AI) models. The language model(s) may process the input data and generate output data (e.g., text data) representing one or more logic conditions for evaluating the requested alert. The logic condition(s) may be derived based on semantics of the user's natural language expression and may correspond to event triggers associated with the application's state. For example, if a user of a gaming application asks to be alerted when they can construct a particular object in the game, the language model(s) may infer the set of required game state conditions (e.g., sufficient resources or game progress milestones) and encode them as executable conditions to be monitored.

In some instances, the language model(s) may be used in a retrieval-augmented generation (RAG) configuration. In such instances, the language model(s) and/or the system(s) may retrieve contextual information from a vector database associated with the application (e.g., game documentation, crafting requirements, or system configurations) to assist in accurately interpreting the user's request/alert specification. For example, if a video game user says, “Let me know when I can build a trade union,” the system(s) may first retrieve the prerequisite game rules or dependencies required to construct that structure. The retrieved content may then be incorporated into a prompt (e.g., the input data) applied to the language model(s) or processing pipeline to enable the language model(s) to generate a precise set of alert conditions based on up-to-date application knowledge.

Although examples may be described herein with respect to using generative AI models, such as language models, this is not intended to be limiting. For example, and without limitation, any of the various AI models described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), small language models (SLMs), vision language models (VLMs), multi-modal language models (MMLMs), large action models (LAMs), vision-language-action (VLA) models, etc.), and/or other types of machine learning models.

As described herein, the language model(s) may generate alert monitoring logic in one or more formats depending on the complexity and/or specificity of the user's alert request. In some instances, the language model(s) may output structured logic expressions, such as 3-tuples that include a state key, a threshold value, and a comparison operator (e.g., (‘timber_count’, 25, ‘greater than or equal to’)). These structured logic expressions may then be evaluated using one or more predefined comparison functions during application runtime, as discussed in greater detail herein. For example, the logic expression (‘enemy_count’, 3, ‘greater than’) may correspond to a user-defined alert such as “alert me when more than three enemies are nearby.” During runtime, a predefined comparison function may retrieve the current value of enemy_count from the application state and apply the ‘greater than’ operator to determine whether the condition is satisfied. Further, although some examples may describe alert logic in terms of individual 3-tuple expressions (e.g., state key, threshold, operator), such expressions may, in some instances, be combined into arbitrary Boolean logic. For example, the system(s) may evaluate multiple comparison expressions and combine their Boolean outcomes using logical operators (e.g., AND, OR, NOT) to form more complex alert conditions.

Additionally, or alternatively, the language model(s) may generate executable code functions (e.g., in C++, Python, or any other programming language) that may analyze one or more elements of the application state and determine whether a specified condition is met. This format may, in some instances, be useful when alert conditions require complex logic or involve multi-step evaluation. For instance, in response to a request such as “notify me when I can start building ships,” the system(s) may use one or more RAG-enhanced language models to retrieve prerequisites for ship-building from a knowledge base (e.g., 150 workers and a steel factory). The language model(s) may then generate a code function that evaluates whether the current state satisfies those prerequisites. In some examples, the generated functions may be compiled into a shared object and/or a dynamically loadable library and invoked during runtime for more advanced alert processing.

In some examples, in addition to—or in the alternative of—generating the alert monitoring logic, the system(s) may continuously apply the original input prompt (e.g., “alert me when 5 minutes remain”) to the language model(s) and/or a second language model(s) to determine whether the alert condition has been satisfied. Alternatively, or additionally, the language model(s) may generate a refined version of the original input prompt to be continuously re-evaluated (e.g., using the language model(s) or the second language model(s)) at runtime to determine whether the alert condition has been satisfied. These techniques may, in some instances be useful in contexts where alerts are ambiguous, contextual, or dependent on visual or temporal information not easily reduced to static conditions. For example, a request like “Let me know when it looks like I'm losing” could be rewritten by the system into a structured prompt such as “Given this current game state, has the player lost a significant advantage?” and submitted to the language model(s) every few seconds alongside live game state data.

Using the generated alert logic—whether in the form of a data structure, executable code, or a language model prompt—the system(s) may monitor states of the interactive application to determine when the specified alert condition has occurred. In some embodiments, alert monitoring may involve periodic evaluation of application state, such as querying key-value pairs that represent runtime variables (e.g., inventory levels, active entities on screen, time remaining, etc.). Additionally, or alternatively, the application state may be accessed directly through an application programming interface (API) associated with the application (e.g., in integrated deployments) or inferred via computer vision and object detection pipelines (e.g., in third-party virtual assistant systems).

In some examples, the frequency of alert logic evaluations may be configurable (e.g., once per second or per frame), and the system(s) may support concurrent monitoring of multiple active alerts. To optimize performance, the system(s) may prioritize or throttle alert evaluations based on user-defined alert priority, system load, and/or frequency of triggering. Additionally, concurrent alert evaluations may be handled in parallel threads or within a dedicated monitoring thread pool to prevent contention with user-facing processes. In various examples, the system(s) may determine that an alert condition is met and trigger one or more user interface elements to notify the user. Depending on the alert type, user preferences, and/or application context, the notification may include, but is not limited to, a popup message, a flashing indicator, a color change in the user interface, a graphical overlay such as a bounding box drawn around an object or character, an audio message or sound, or any other visual or auditory indicator. In some examples, the user may specify how they prefer to be alerted, such as by choosing visual, textual, or auditory indicators. The alert display system may also adapt its behavior depending on the alert's priority or associated game state variable—e.g., flashing red for critical alerts or showing a non-intrusive log message for less urgent ones.

In some instances, the system(s) may be configured to support alert snoozing or disabling functionality, allowing users to temporarily silence or disable alerts. For example, when an alert is triggered, the system(s) may automatically suppress repeated notifications for a predefined duration (e.g., five seconds) or allow the user to manually snooze the alert for a configurable time interval (e.g., five minutes or one hour). The snoozing/disabling mechanism may also help ensure that alerts remain informative and contextually relevant without becoming disruptive. The system(s) may also allow previously snoozed alerts to be re-enabled via user requests. Additionally, when registering a new alert, the system(s) may check for semantic equivalence with existing alerts. If a match is found, the system(s) may surface the prior alert and request confirmation before proceeding, helping to reduce duplication and streamline alert management.

In some embodiments, the system(s) may maintain a list of active alerts and expose an interface that enables the user to review, pause, or disable alerts as desired. This may help prevent redundant alerts from overwhelming the user, particularly in cases where a triggering condition remains true for an extended period of time. In some examples, the system(s) may further support alert management operations beyond registration. For instance, users may issue natural language requests such as “list my alerts” or “what alerts are active,” prompting the system(s) to return a structured summary of currently registered alerts. The listing may include a numeric identifier, the logic condition(s) (e.g., in structured or natural language form), and/or an active status such as Enabled, Disabled, or Snoozed. In some instances, one or more (e.g., each) of the alerts may also include a descriptive name, which may be automatically generated by a language model or provided by the user.

In some examples, one or more of the various generative AI models (e.g., language models, LLMs, SLMs, VLMs, MMLMs, vision-language-action (VLA) models, etc.) described herein may be packaged as a microservice-such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the AI model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the AI model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's Tensor™), and/or enterprise management data for telemetry (e.g., including identity, metrics, health checks, and/or monitoring). The generative AI model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the AI model(s) (e.g., that has been optimized for high performance inference), an inference runtime software to execute the AI model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

In one or more embodiments, the systems and methods described herein may be deployed within a gaming application that includes or is augmented by a virtual AI assistant. For example, a gaming console, PC, tablet, or other interactive gaming device may include one or more onboard and/or remote processors (e.g., CPUs, GPUs, AI accelerators, or SoCs) as well as local or remote memory/storage to support gameplay and assistant functionality. These devices may execute the core game engine and, in parallel, operate an AI assistant capable of processing natural language input from the user, including alert requests. In some embodiments, one or more language models (e.g., large language models (LLMs), small language models (SLMs), vision-language models (VLMs), or multimodal models) may be deployed to convert user-provided natural language expressions into structured alert logic that is continuously evaluated during gameplay. This processing may occur locally on the user's device or remotely within a cloud-hosted environment.

For example, in a cloud gaming context (e.g., NVIDIA's GeFORCE NOW), the AI assistant may operate as a cloud service, receiving input prompts from the player's client device (e.g., controller, headset, or keyboard input), generating structured logic or executable alert-checking functions, and returning alert notifications or UI overlays to the client in real time. The assistant may access game state data through integration with the game engine or via visual inference pipelines (e.g., OCR and object detection) to monitor for user-defined conditions. In such cloud-based deployments, remote rendering, alert processing, and LLM evaluation may be performed on data center infrastructure, while lightweight client devices may handle input capture and display.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

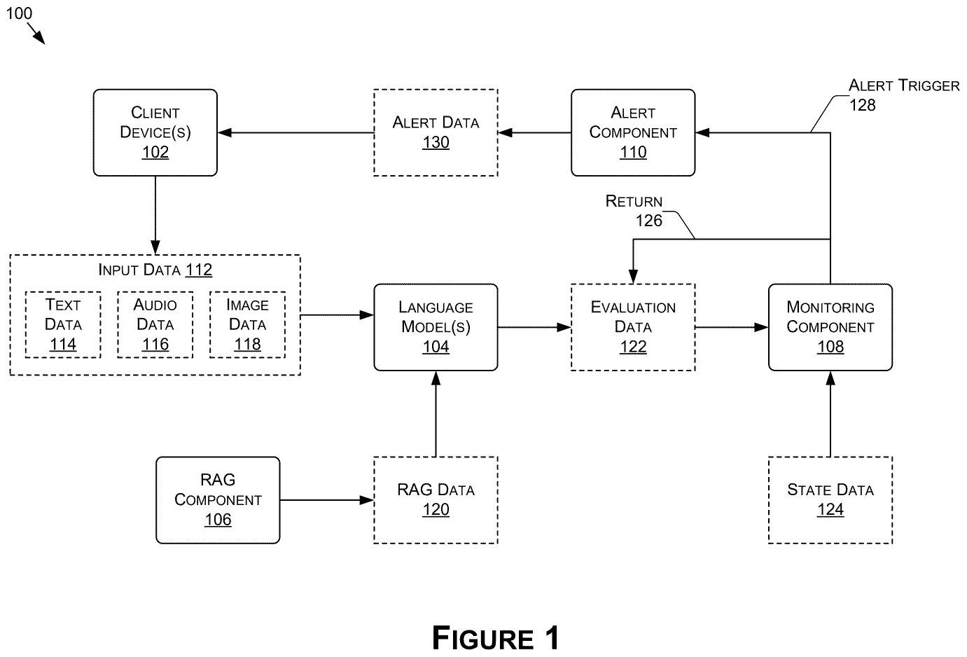

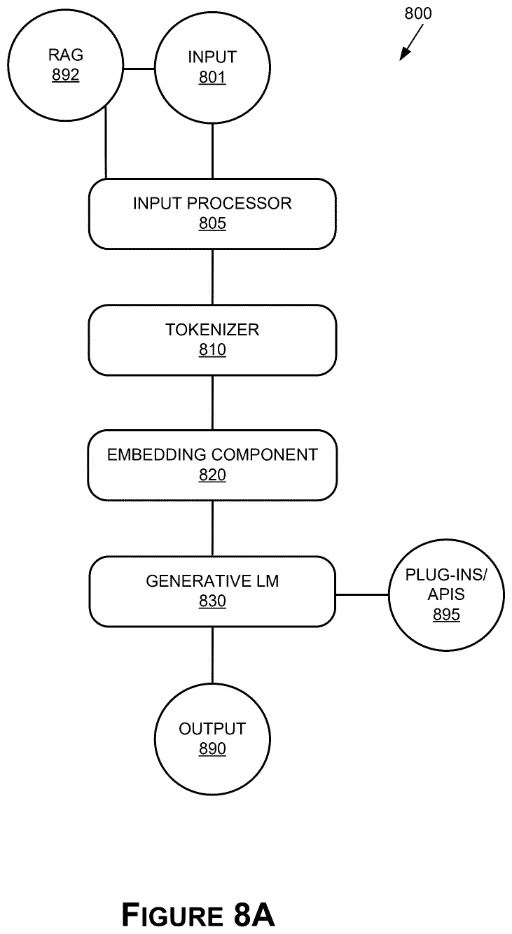

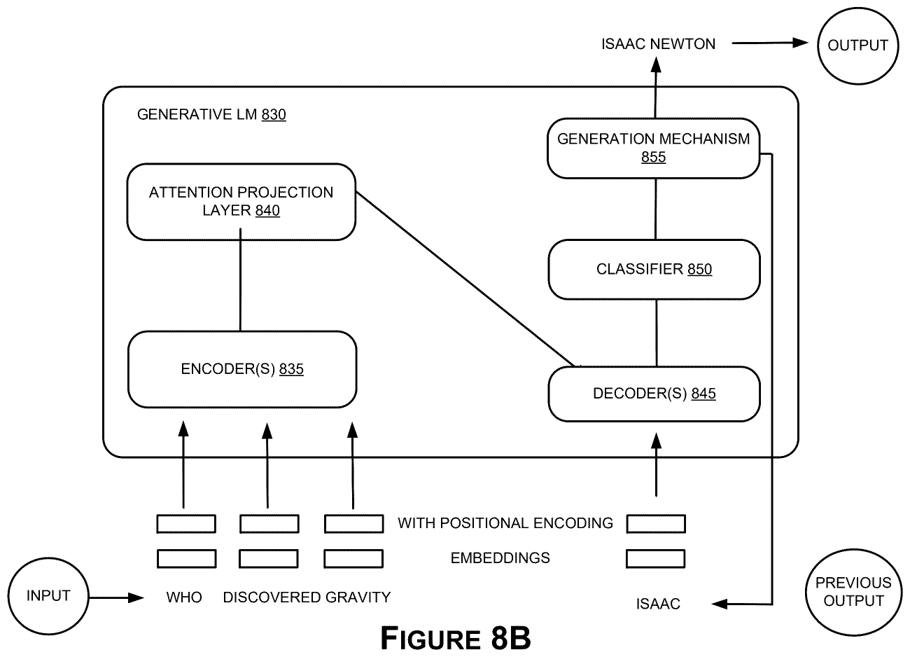

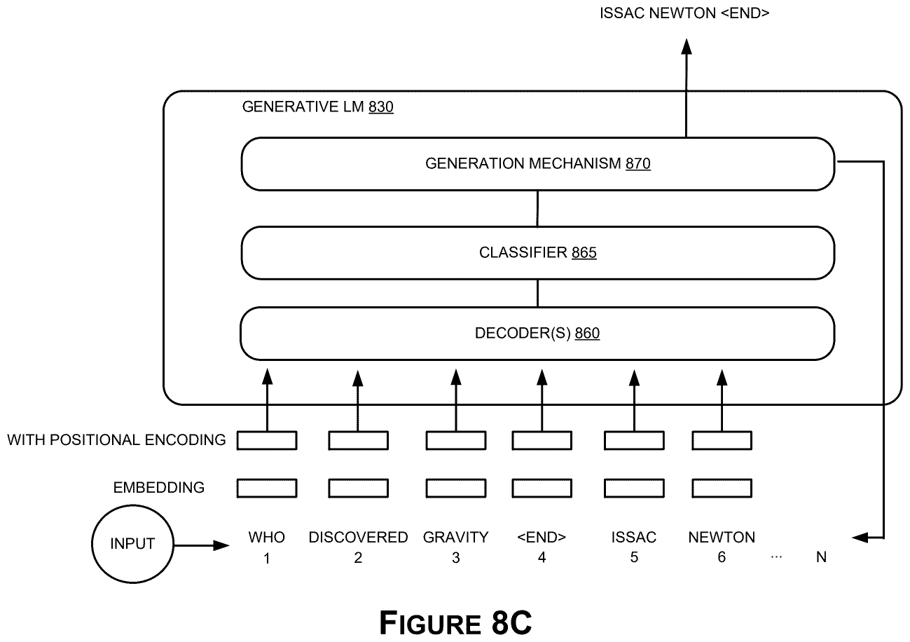

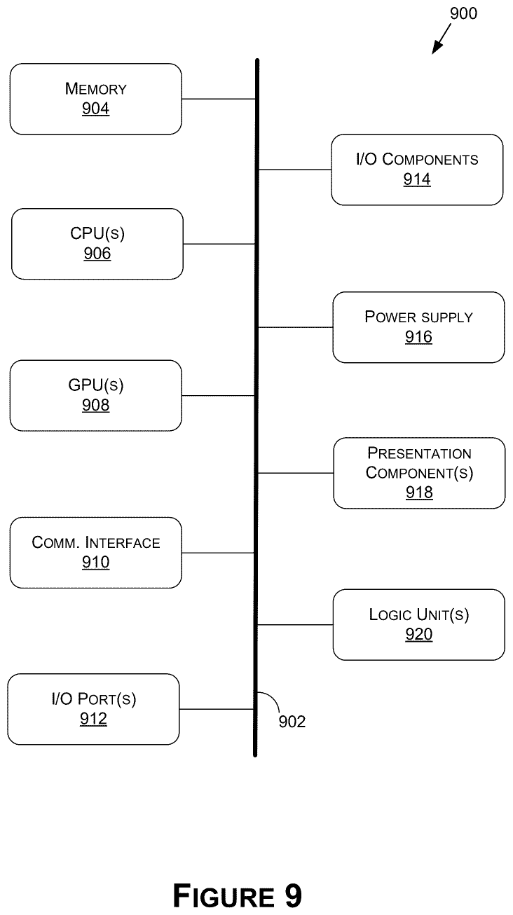

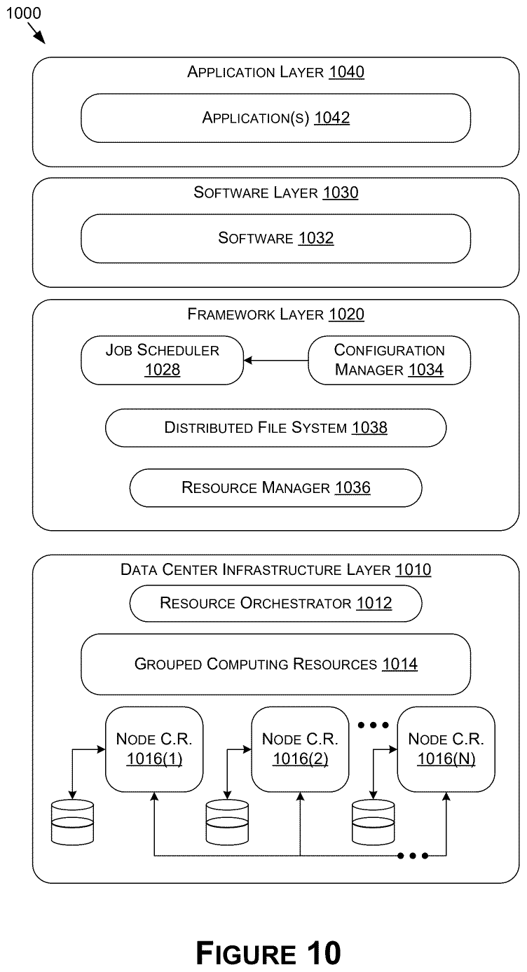

With reference to FIG. 1, FIG. 1 is a data flow diagram illustrating an example of a process 100 for implementing user-defined alerts for an interactive application, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 8A-8C), one or more computing devices or components thereof (e.g., as described in FIG. 9), and/or one or more data centers or components thereof (e.g., as described in FIG. 10).

As shown, the process 100 may be implemented using, amongst additional or alternative components, one or more client devices 102, one or more language models 104, a RAG component 106, a monitoring component 108, and an alert component 110. In some examples, one or more of these components may correspond to an application assistant system (e.g., application virtual assistant system). As a brief overview of the process 100, input data 112—which may include text data 114, audio data 116, and/or image data 118—representing a natural language alert specification may be received from the client device(s) 102 and applied as input to the language model(s) 104. Additionally, in some examples, the RAG component 106 may apply RAG data 120 representing contextual and/or other application-related information as input to the language model(s) 104. The language model(s) 104 may process the input data 112 and the RAG data 120 and generate evaluation data 122, which may represent one or more logic conditions for triggering an alert. The monitoring component 108 may evaluate state data 124 representing a state of the application with respect to the evaluation data 122 to determine whether to return 126 and re-evaluate the evaluation data 122 with respect to new state data 124 (e.g., for the next state of the application) or trigger the alert. Based on the monitoring component 108 issuing an alert trigger signal 128, the alert component 110 may generate alert data 130 to cause the alert to be output by the client device(s) 102.

In some examples, the client device(s) 102 may include any computing device capable of executing an interactive application (e.g., a game, productivity tool, or creative environment) and interfacing with a virtual assistant. For instance, an example client device(s) 102 may include, but is not limited to, a gaming console, a personal computer (PC), a tablet, a smart display, a mobile phone, an augmented or virtual reality headset, or any combination thereof. In some embodiments, the client device(s) 102 may include local processing and memory resources to support alert specification input and alert output rendering. Additionally, or alternatively, in cloud-based architectures, the client device(s) 102 may operate as thin clients, transmitting input and receiving alert feedback from remote servers or data centers. The client device(s) 102 may also display alert notifications, visual overlays, or other user interface elements based on output received from the alert component 110.

The input data 112 may include one or more forms of data representing an alert specification provided by user of the client device(s) 102. The input data 112 may include, but is not limited to, the text data 114 (e.g., typed or transcribed speech), the audio data 116 (e.g., a spoken phrase or sound cue), and/or the image data 118 (e.g., a screenshot or in-application visual symbol). The input data 112 may be generated by the client device(s) 102 and transmitted to the application assistant system for processing. In some examples, the input data 112 may include metadata such as timestamps, game context, or user preferences to provide additional context for interpreting the alert specification. As shown, the input data 112 may be applied to the language model(s) 104 as part of an input prompt.

In some examples, the language model(s) 104 may include one or more artificial intelligence (AI) models configured to process natural language, multimodal input, or contextual data to generate alert monitoring logic, which may be represented using the evaluation data 122. In various instances, the language model(s) 104 may include one or more of large language models (LLMs), multimodal language models (MMLMs), vision-language models (VLMs), small language models (SLMs), and/or any other kinds of generative AI models. In some examples, the language model(s) 104 may be fine-tuned on—or supplemented with—application-specific data to process the input data 112 and generate the evaluation data 122.

For instance, in at least some examples, the application assistant system may apply the RAG data 120 to the language model(s) 104 prior to, or in conjunction with (e.g., as part of the input prompt), the input data 112. In such examples, the RAG component 106 may facilitate retrieval-augmented generation by enriching the prompt provided to the language model(s) 104 with relevant context. For example, the RAG component 106 may query one or more vector databases to retrieve the RAG data 120 representing application documentation, application metadata, and/or user-specific knowledge graphs. This information may help the language model(s) 104 interpret user inputs and ensure the language model(s) 104 produces logic conditions that are accurate and aligned with current application parameters. For instance, in a strategy game, if the user requests an alert to “let me know when I can build ships,” the RAG component 106 may retrieve crafting prerequisites from in-game documentation to inform logic generation.

Although examples may be described herein with respect to using generative AI models, such as language models, this is not intended to be limiting. For example, and without limitation, any of the various AI models described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), small language models (SLMs), vision language models (VLMs), multi-modal language models (MMLMs), large action models (LAMs), vision-language-action (VLA) models, etc.), and/or other types of machine learning models.

As described herein, the language model(s) 104 may generate the evaluation data 122 (e.g., text data) in one or more formats, where the chosen format may depend on the complexity and/or specificity of the user's alert request. That is, the language model(s) 104 may determine whether a complexity score associated with either the alert request or monitoring the alert meets or exceeds one or more thresholds, and then generate the evaluation data 122 in a format for the given complexity score. For instance, the language model(s) 104 may generate the evaluation data 122 to represent one or more logic expressions for simpler alerts, such as alerts that may depend on a single (or multiple) state keys or values. In such examples, the logic expression(s) may be represented as 3-tuple data structures that include a state key, a threshold value, and a comparison operator. As an example, for the logic expression (‘timber_count’, 25, ‘greater than or equal to’), the alert may be triggered when the value for the ‘timber_count’ state variable is greater than or equal to 25.

Additionally, or alternatively, the language model(s) 104 may generate the evaluation data 122 to represent one or more executable code functions (e.g., in C++, Python, or any other programming language) that may analyze one or more elements of the application state and determine whether a specified condition is met. In such examples, the language model(s) 104 may generate these code functions for more complex alerts, such as alerts that might depend on multiple different state key-values. As an example, a natural language alert specification that references multiple conditions—such as “notify me when my health drops below 30% and I have fewer than two healing potions”—may require logic that evaluates multiple state keys and applies conditional logic across them. In such cases, the language model(s) 104 may be prompted to generate a complete function that accepts a structured application state (e.g., a map or dictionary of key-value pairs) and returns a Boolean value indicating whether the composite alert condition has been satisfied. These generated code functions may include nested conditionals, logical operators, or arithmetic expressions, and may be stored as part of the evaluation data 122 for use during alert monitoring.

In even further examples, the evaluation data 122 may represent one or more language model input prompts to be applied to the language model(s) 104 or a second language model(s). In such examples, the language model input prompt(s) may simply include the same input prompt applied to the language model(s) 104 based on the input data 112, or the input prompt(s) may include updated or refined input prompts generated by the language model(s) 104. These techniques may, in some instances be useful in contexts where alerts are ambiguous, contextual, or dependent on visual or temporal information not easily reduced to static conditions. For example, a request like “Let me know when it looks like I'm losing” could be rewritten by the system into a structured prompt such as “Given this current game state, has the player lost a significant advantage?” and submitted to the language model(s) every few seconds alongside live game state data.

While these are just a few examples of the various formats of logic conditions the evaluation data 122 may represent and be generated by the language model(s) 104, in additional or alternative examples, the language model(s) 104 may generate any kinds of conditions, rules, or procedures to be used (e.g., by the monitoring component 108) to determine whether to trigger a user-defined alert. Additionally, it should be appreciated that any of the different formats of logic conditions, rules, procedures, etc. described herein (e.g., 3-tuple logic expressions, code functions, language model calls/prompts, etc.—as well as combinations thereof) may be used to evaluate any complexity level of alert request. For instance, 3-tuple logic expressions may also be used to monitor complex alert requests (e.g., not just code functions), code functions may be used to evaluate simple alert requests, and so forth.

The process 100 may also include the monitoring component 108 receiving the evaluation data 122 generated using the language model(s) 104. The monitoring component 108 may be configured to evaluate the application state with respect to the logic conditions represented by the evaluation data 122. For instance, the monitoring component 108 may obtain or otherwise evaluate the state data 124, which may represent or include key-value pairs or other representations of the application state during runtime. In some instances, the values for these key-value pairs may be obtained through direct integration with the application (e.g., via API) or inferred through perceptual data (e.g., from computer vision or object recognition) by analyzing image frames associated with the application using one or more AI models, such as one or more VLMs.

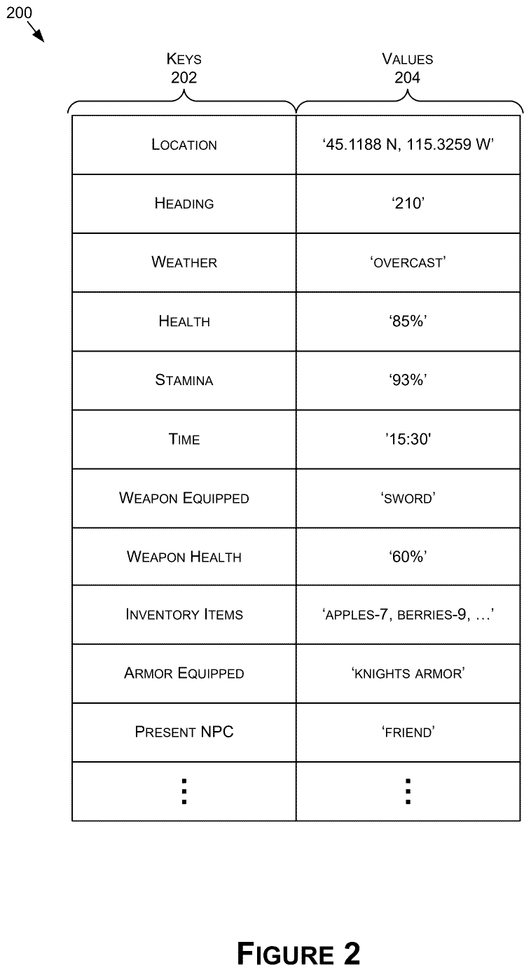

For instance, FIG. 2 illustrates examples of key-value pairs 200 indicative of a state associated with an application, in accordance with some embodiments of the present disclosure. As shown, the key-value pairs 200 may include a plurality of keys 202 and a plurality of values 204 corresponding to the keys 202. The keys 202 may correspond to various specific attributes, variables, or parameters associated with the current runtime state of the application. The values 204 may represent real-time or recently updated values associated with those keys 202. In some examples, the key-value pairs 200 may be stored in a data structure (e.g., a map, dictionary, or associative array) that can be accessed by the monitoring component 108 to evaluate whether any alert conditions are satisfied. These key-value pairs 200 may be updated frequently based on internal application logic, API polling, or computer vision-derived inference pipelines.

As illustrated in the example of FIG. 2, the key-value pairs 200 may include application state keys 202 corresponding to application state-related information such as location (e.g., location of a player within a game environment), heading (e.g., heading of the player within the game environment), weather (e.g., current weather in the game environment), health (e.g., health of the player), stamina (e.g., stamina of the player), time (e.g., local time or time within the game environment world), weapon equipped (e.g., weapon the player is wielding), weapon health (e.g., ammo count, time until failure, etc.), inventory items, and armor equipped, among others. Each of these keys 202 may correspond to a value 204. For instance, the value for the location key may be a geographic coordinate (e.g., 45.1188 N, 115.3259 W) indicating the player's current in-game position. The heading key may represent a directional bearing, such as 210-degrees, which could be used to determine the orientation of the user or player-controlled entity. Other examples shown include weather set to ‘overcast,’ health at ‘85%,’ and stamina at ‘93%,’ which may indicate the player's environmental and physical condition. Similarly, time set to ‘15:30’ may reflect either in-game time or real-world system time, depending on implementation.

Now referring back to the example of FIG. 1, the process 100 may include the monitoring component 108 evaluating the state data 124 continuously and/or periodically (e.g., per frame or time interval) using the evaluation data 122 (e.g., the logic conditions represented in the evaluation data 122). Based on this evaluation, the monitoring component 108 may determine whether an alert condition has been met. If not, the process 100 may return 126 the evaluation data 122 for subsequent evaluation as the state data 124 continues to update. Otherwise, if the monitoring component 108 determines the logic condition(s) is true and, therefore, the alert condition is met, the monitoring component 108 may issue the alert trigger signal 128. In some examples, the monitoring component 108 may evaluate whether to trigger alert conditions in a number of different ways based on the format of the evaluation data 122. For instance, where the evaluation data 122 includes a structured 3-tuple (e.g., state key, comparison operator, and threshold value), the monitoring component 108 may apply that 3-tuple to a predefined comparison function for evaluation. Additionally, or alternatively, where the evaluation data 122 includes an executable code function, the monitoring component 108 may invoke or execute the function directly to determine whether the alert condition is satisfied. In still other cases, the evaluation data 122 may include a prompt that is re-applied to one or more language models (e.g., the language model(s) 104 and/or another model(s)) to generate a runtime response indicating whether the condition has been met.

Upon receiving the alert trigger signal 128, the alert component 110 may generate the alert data 130 representing one or more outputs to notify the user of the client device(s) 102 that the alert condition was met. These outputs may include visual, auditory, or haptic feedback depending on the alert type and user settings. For instance, the alert data 130 may represent visual and/or auditory content to be output using the client device(s) 102 in response to the alert. This may include static UI elements (e.g., popup text), dynamic overlays (e.g., bounding boxes), visual effects (e.g., flashing elements), informational indicators (e.g., resource bars), audio messages (e.g., natural language speech), sounds or tones, or any other outputs.

In some embodiments, prior application frames being rendered on the client device(s) 102, the alert component 110 may modify or composite the rendered frames using the alert data 130 to visually reflect the triggered alert. For example, the alert component 110 may draw a dashed box around a specific object or character in the frame (e.g., an NPC such as a ‘Dodo’) or apply a temporary color filter or animation to indicate the alert condition has been satisfied. These modifications, in some examples, may occur on the server side or intermediate rendering pipeline and be streamed to the client device(s) 102 as part of the final video or image frame. In some examples, these alterations may be frame-limited or time-bounded (e.g., displayed for 3-5 seconds) to avoid persistent visual clutter. The alert component 110 may determine the appropriate form of visual augmentation based on the type of alert and associated state key.

Similarly, for auditory alerts, the alert component 110 may inject synthesized speech (e.g., using a TTS system), pre-recorded audio messages, or tonal indicators into the outgoing audio stream before it reaches the client device(s) 102. This may allow alerts to be communicated in real time without requiring the client device(s) 102 to perform additional decoding or playback logic. The visual and auditory alert outputs may be selected based on default preferences, context-specific relevance (e.g., alert severity), or user-configured display modes.

In some examples, the alert component 110 may also manage alert lifecycle events, such as snoozing, repeating, disabling, or updating alert preferences. For example, upon detecting that an alert condition has been met and an alert has been displayed, the alert component 110 may initiate a snoozing timer that temporarily suppresses repeated notifications for that specific alert, such as for a fixed duration (e.g., five seconds, one minute, or user-configured intervals). In some embodiments, the alert component 110 may support user-driven alert snoozing, enabling users to manually pause or defer individual alerts through an interactive menu or toggle control. Additionally, the alert component 110 may manage repeating alerts by determining whether to re-display alerts if a triggering condition remains true over multiple application states. In some examples, alerts may be configured to trigger only once per session, or to repeat until explicitly acknowledged or dismissed by the user. The alert component 110 may also expose controls that allow users to update the conditions, thresholds, or display styles associated with existing alerts, thereby supporting a dynamic and user-customizable alerting system that adapts in real time to evolving gameplay or application scenarios.

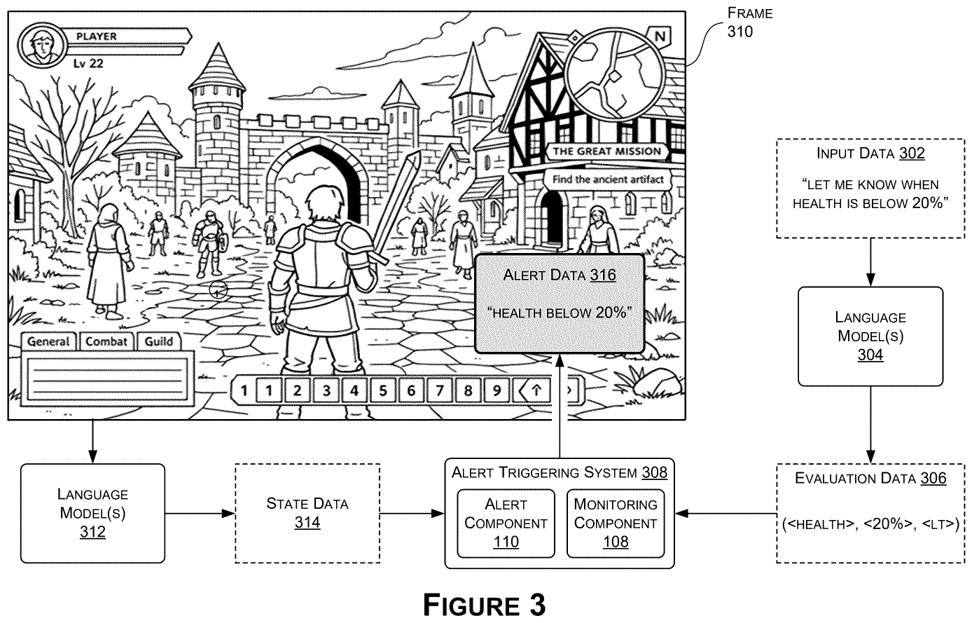

Now referring to FIG. 3, FIG. 3 illustrates an example of converting a natural language request into logic for triggering a user-defined alert, in accordance with some embodiments of the present disclosure. As shown, input data 302 may represent a natural language instruction provided by a user of an interactive application. For instance, the natural language instruction includes a request to “let me know when health is below 20%.” The input data 302 may be provided via a client device through text, speech, or other modalities, and submitted to one or more language models 304 for processing.

The language model(s) 304—which may correspond to the language model(s) 104—may interpret the semantics of the natural language input and generate corresponding evaluation data 306, which includes one or more logic expressions or structured conditions based on application state keys. In the illustrated example, the evaluation data 306 includes a 3-tuple expression: (<HEALTH>, <20%>, <LT>), representing the alert condition that should be satisfied when the value of the “HEALTH” state key is less than (e.g., “LT”) 20-percent. This evaluation data 306 may be forwarded to an alert triggering system 308, which may include the monitoring component 108 and the alert component 110, as previously described with respect to FIG. 1.

The monitoring component 108 may receive state data 314 reflecting current or periodically updated application states—such as HEALTH=19% and TIME=5. The state data 314 may be derived from the application's runtime engine, an API, or a visual analysis pipeline. For instance, a frame 310 associated with the application may be applied to one or more language models 312 (e.g., a vision language model, multimodal language model, etc.). The language model(s) 312 may, in some instances, be the same as or different from the language model(s) 304. The language model(s) 312 may process the frame 310 to generate or update the state data 314, which may include the key-value pairs 200 representative of the application state. For instance, the language model(s) 312 may process the frame 310 and assign values of “19%” and “5” to the state keys of HEALTH and TIME, respectively.

The monitoring component 108 may compare the state data 314 against the evaluation data 306 and determine that the alert condition is met (e.g., 19% <20% evaluates to true). Based on this determination, the monitoring component 108 may signal the alert component 110 to generate a user-facing alert.

In response to the triggered alert, the alert component 110 may produce alert data 316 to be rendered to the user. As shown, the alert data 316 includes a visual notification—e.g., a popup or overlay indicating “HEALTH BELOW 20%.” This alert may be rendered within the application's active frame 310, which includes gameplay elements such as a player character, user interface controls, health bars, a mini-map, and inventory elements. The alert may be composited onto the game frame prior to rendering or streaming to the user's display. Additionally, in some examples, the alert data 316 may be audibly output. For instance, machine-generated speech uttering the expression “health below 20-percent” may be generated and included in the alert data 316, and the client device may output the audio data in addition to, or in the alternative of, the visual notification.

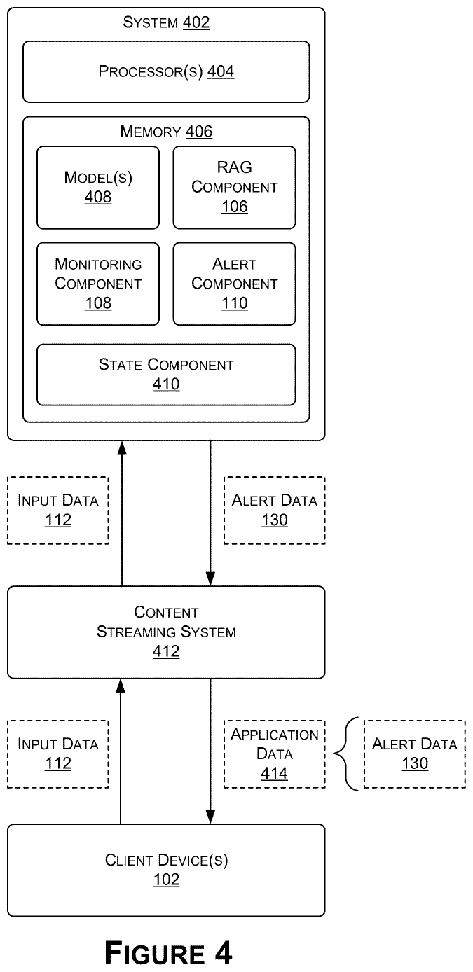

Now referring to the example of FIG. 4, FIG. 4 is a block diagram illustrating an example of a system 402 that may perform one or more of the processes, methods, or techniques of the present disclosure. As shown, the system 402 may include one or more processor(s) 404 (which may correspond to the one or more CPUs 906 and/or the one or more GPUs 908 of the example computing device 900) and memory 406 (which may correspond to the memory 904 of the example computing device 900). In various examples, the processor(s) 404 may execute one or more software components stored in the memory 406 to carry out one or more of the methods or operations described herein. For instance, the software component(s) stored in the memory 406 may include one or more of the RAG component 106, the monitoring component 108, the alert component 110, one or more models 408 (which may correspond to the language model(s) 104), and/or a state component 410, and the processor(s) 404 may execute one or more of these component(s) to convert natural language alert specifications into user-defined alert logic that is then monitored to issue alerts to a user based on application state updates or events.

For example, the system 402 may receive, from the client device(s) 102 via a content streaming system 412 (which may correspond to the application server(s) 702), input data 112 representing a natural language request to alert or notify a user of the client device(s) 102 upon the occurrence of some specified condition(s). The system 402 may process the input data 112 using the model(s) 408 to generate alert monitoring logic (e.g., evaluation data 122) and the monitoring component 108 may evaluate this logic with respect to application state information received from the state component 410. Upon determination that the alert logic condition(s) is met, the monitoring component 108 may trigger the alert component 110 to generate alert data 130 for outputting the alert to the user. The alert data 130 may then be used to modify application data 414, which may represent an image frame or audio output associated with the application, and send to the client device(s) 102.

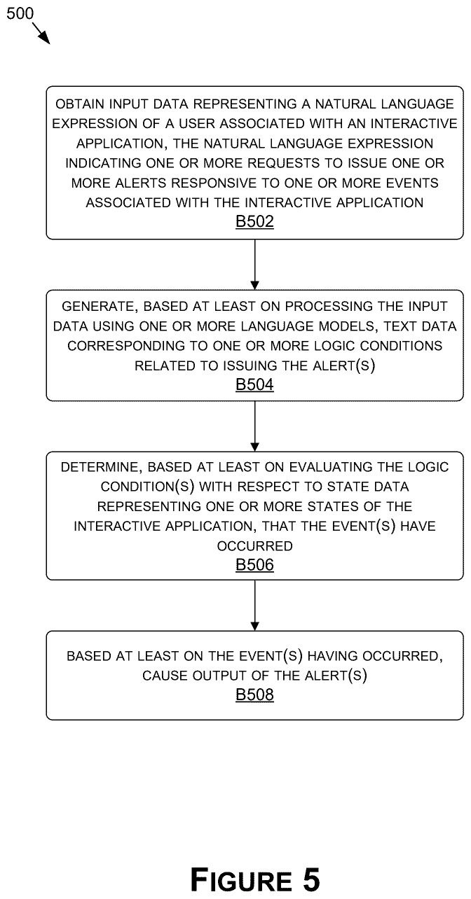

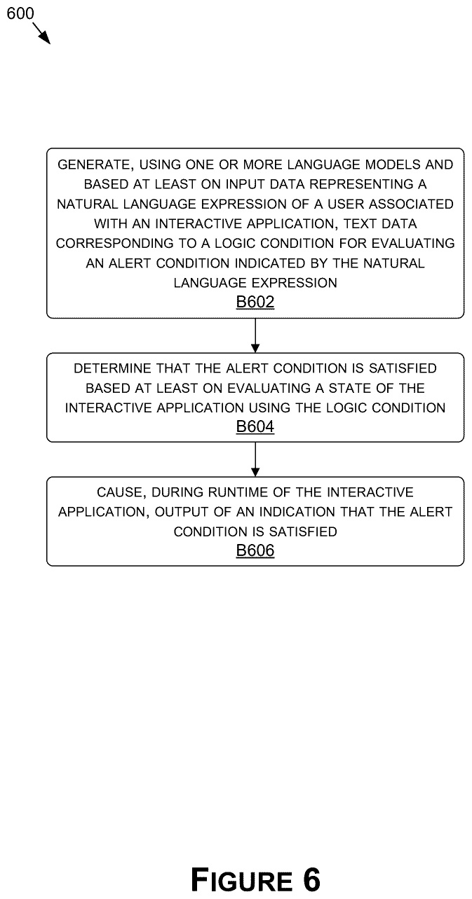

Now referring to FIGS. 5 and 6, each block of methods 500 and 600, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 500 and 600 are described, by way of example, with respect to the application assistant system of FIG. 1. However, this method may additionally or alternatively be executed by any one system, or any combination of systems, including, but not limited to, those described herein.

Referring first to FIG. 5, FIG. 5 is a flow diagram illustrating an example of a method 500 for implementing user-defined alerts for an interactive application, in accordance with some embodiments of the present disclosure. The method 500, at block B502, may include obtaining input data representing a natural language expression of a user associated with an interactive application, the natural language expression indicating one or more requests to issue one or more alerts responsive to one or more events associated with the interactive application. The input data may be received during execution of the interactive application, such as during a session of the interactive application. For example, the application assistant system may obtain the input data 112 representing the natural language expression of a user(s) of the client device(s) 102, which may be executing or streaming the interactive application.

The method 500, at block B504, may include generating, based at least on processing the input data using one or more language models, text data corresponding to one or more logic conditions related to issuing the alert(s). For instance, the application assistant system may apply the input data 112 as at least part of an input prompt to the language model(s) 104, and the language model(s) 104 may generate evaluation data 122 (e.g., text data) representing the logic condition(s) related to issuing the alert(s).

The method 500, at block B506, may include determining, based at least on evaluating the logic condition(s) with respect to state data representing one or more states of the interactive application, that the event(s) have occurred. For instance, the monitoring component 108 may determine the event(s) have occurred based at least on evaluating the logic condition(s) represented using the evaluation data 122 with respect to the state data 124.

The method 500, at block B508, may include causing output of the alert(s) based at least on the event(s) having occurred. The alert(s) may be output during the session of the interactive application. For instance, based at least on determining the event(s) occurred, the monitoring component 108 may send the alert trigger signal 128 to the alert component 110. The alert component 110 may then generate and forward the alert data 130 to the client device(s) 102 (e.g., within application data).

FIG. 6 is a flow diagram illustrating an example of a method 600 for converting a natural language alert specification into logic conditions for triggering a user-defined alert associated with an application, in accordance with some embodiments of the present disclosure. The method 600, at block B602, may include generating, using one or more language models and based at least on input data representing a natural language expression of a user associated with an interactive application, text data corresponding to a logic condition for evaluating an alert condition indicated by the natural language expression. For example, the language model(s) 104 may process the input data 112 and the RAG data 120 to generate the evaluation data 122 (e.g., text data) corresponding to the logic condition for evaluating the alert condition.

The method 600, at block B605, may include determining that the alert condition is satisfied based at least on evaluating a state of the interactive application using the logic condition. For instance, the monitoring component 108 may determine the alert condition is satisfied based at least on evaluating the state data 124 representing the state of the interactive application with respect to the logic condition represented using the evaluation data 122.

The method 600, at block B606, may include causing, during runtime of the interactive application, output of an indication that the alert condition is satisfied. For instance, the monitoring component 108 may send the alert trigger signal 128 to the alert component 110. The alert component 110 may then generate and forward the alert data 130 to the client device(s) 102 (e.g., within application data).

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Content Streaming System

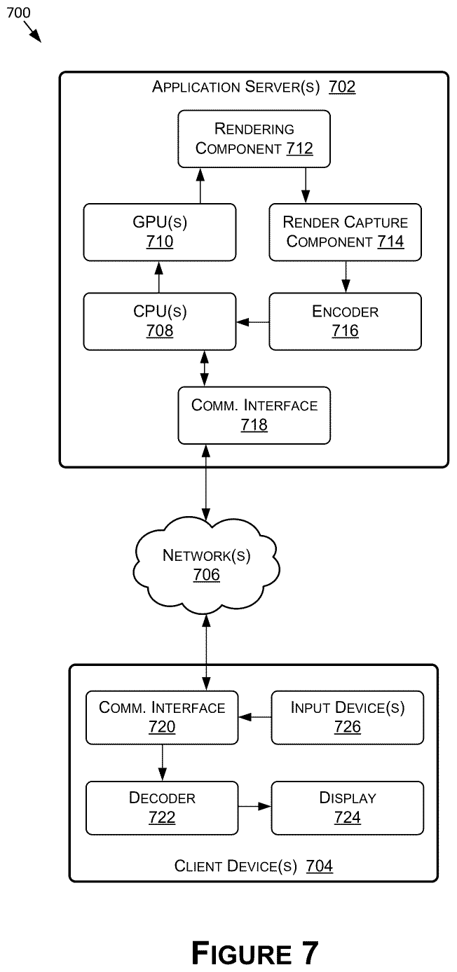

Now referring to FIG. 7, FIG. 7 is an example system diagram for a content streaming system 700, in accordance with some embodiments of the present disclosure. FIG. 7 includes application server(s) 702 (which may include similar components, features, and/or functionality to the example computing device 900 of FIG. 9), client device(s) 704 (which may include similar components, features, and/or functionality to the example computing device 900 of FIG. 9), and network(s) 706 (which may be similar to the network(s) described herein). In some embodiments of the present disclosure, the system 700 may be implemented. The application session may correspond to a game streaming application (e.g., NVIDIA GeForce NOW), a remote desktop application, a simulation application (e.g., autonomous or semi-autonomous vehicle simulation), computer aided design (CAD) applications, virtual reality (VR), augmented reality (AR), and/or mixed reality (MR) streaming applications, deep learning applications, and/or other application types.

In the system 700, for an application session, the client device(s) 704 may only receive input data in response to inputs to the input device(s), transmit the input data to the application server(s) 702, receive encoded display data from the application server(s) 702, and display the display data on the display 724. As such, the more computationally intense computing and processing is offloaded to the application server(s) 702 (e.g., rendering—in particular ray or path tracing—for graphical output of the application session is executed by the GPU(s) of the game server(s) 702). In other words, the application session is streamed to the client device(s) 704 from the application server(s) 702, thereby reducing the requirements of the client device(s) 704 for graphics processing and rendering.

For example, with respect to an instantiation of an application session, a client device 704 may be displaying a frame of the application session on the display 724 based on receiving the display data from the application server(s) 702. The client device 704 may receive an input to one of the input device(s) and generate input data in response. The client device 704 may transmit the input data to the application server(s) 702 via the communication interface 720 and over the network(s) 706 (e.g., the Internet), and the application server(s) 702 may receive the input data via the communication interface 718. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 712 may render the application session (e.g., representative of the result of the input data) and the render capture component 714 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 702. In some embodiments, one or more virtual machines (VMs)—e.g., including one or more virtual components, such as vGPUs, vCPUs, etc.—may be used by the application server(s) 702 to support the application sessions. The encoder 716 may then encode the display data to generate encoded display data and the encoded display data may be transmitted to the client device 704 over the network(s) 706 via the communication interface 718. The client device 704 may receive the encoded display data via the communication interface 720 and the decoder 722 may decode the encoded display data to generate the display data. The client device 704 may then display the display data via the display 724.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)-such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/VLM/MMLM/etc.). In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 (which may include one or more RAG models, and/or may be performed using the generative LM 830 itself) may be used to retrieve additional information to be used as part of the input 801 or prompt. RAG may be used to enhance the input to the LLM/VLM/MMLM/etc. with external knowledge, so that answers to specific questions or queries or requests are more relevant-such as in a case where specific knowledge is required. The RAG component 892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features—such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use—or capable of accessing or using—plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated—e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources—such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer 810 of FIG. 8A) into tokens such as words, and each token is encoded (e.g., by the embedding component 820 of FIG. 98A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may use distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Example Clauses

A. A method comprising: obtaining input data representing at least one natural language expression of a user associated with an interactive application, the at least one natural language expression indicating one or more requests to issue one or more alerts responsive to one or more events associated with the interactive application; generating, based at least on processing the input data using one or more language models, text data corresponding to one or more logic conditions related to issuing the one or more alerts; determining, based at least on evaluating the one or more logic conditions with respect to state data representing one or more states of the interactive application, that the one or more events have occurred; and based at least on the one or more events having occurred, causing output of the one or more alerts.
B. The method of paragraph A, wherein the text data represents one or more data structures corresponding to the one or more logic conditions, the one or more data structures including at least one or more identifiers of one or more state keys, one or more threshold values, and one or more comparison operators.
C. The method of any one of paragraphs A-B, wherein the text data represents code corresponding to the one or more logic conditions, the code including one or more functions to determine whether the one or more events have occurred based at least on evaluating one or more state key values indicative of the one or more states of the interactive application.
D. The method of any one of paragraphs A-C, wherein the code comprises one or more functions, the method further comprising: compiling the code into one or more dynamically loadable libraries; and executing, during runtime of the interactive application, at least one of the one or more functions from the one or more dynamically loadable libraries to evaluate whether the one or more events have occurred.
E. The method of any one of paragraphs A-D, wherein the text data represents a natural language prompt corresponding to the one or more logic conditions, the method further comprising: applying the text data as an input prompt to one or more second language models; and obtaining, based at least on the one or more second language models processing the text data and the state data, output data indicating whether the one or more events have occurred, wherein the determining that the one or more events have occurred is based at least on the output data.
F. The method of any one of paragraphs A-E, further comprising: obtaining, from one or more vector databases associated with the interactive application, data representing contextual information corresponding to the interactive application, wherein the generating of the text data using the one or more language models is further based at least on the one or more language models processing the data representing the contextual information.
G. A system comprising one or more processors to: generate, using one or more language models and based at least on input data representing at least one natural language expression of a user associated with an interactive application, text data corresponding to a logic condition for evaluating an alert condition indicated by the at least one natural language expression; determine that the alert condition is satisfied based at least on evaluating a state of the interactive application using the logic condition; and cause, during runtime of the interactive application, output of an indication that the alert condition is satisfied.
H. The system of paragraph G, wherein the text data represents a data structure corresponding to the logic condition, the data structure including at least an identifier of a state key, a threshold value, and a comparison operator.
I. The system of any one of paragraphs G-H, wherein the evaluating the state of the interactive application comprises: obtaining state data representing key-value pairs indicative of the state of the interactive application, the key-value pairs including the state key; and evaluating, using the comparison operator, a value of the state key with respect to the threshold value.
J. The system of any one of paragraphs G-I, wherein the text data represents code corresponding to the logic condition, the code including a function to determine whether the alert condition is satisfied based at least on evaluating one or more state key values associated with the state of the interactive application.
K. The system of any one of paragraphs G-J, the one or more processors further to: compile the code into a dynamically loadable library; and execute, during runtime of the interactive application, the function from the dynamically loadable library.
L. The system of any one of paragraphs G-K, the one or more processors further to: obtain, from a vector database associated with the interactive application, data representing contextual information corresponding to the interactive application, wherein the generation of the text data using the one or more language models is further based at least on the one or more language models processing the data representing the contextual information.
M. The system of any one of paragraphs G-L, wherein causing the output of the indication comprises rendering, within a graphical user interface associated with the interactive application, one or more visual indications that the alert condition is satisfied.
N. The system of any one of paragraphs G-M, wherein the evaluating the state of the interactive application using the logic condition comprises: evaluating, at a first time, one or more first values of one or more state variables representative of the state of the interactive application; and evaluating, at a second time after the first time, one or more second values of the one or more state variables.
O. The system of any one of paragraphs G-N, wherein: the first time corresponds to a first session of the interactive application, and the second time corresponds to a second session of the interactive application.
P. The system of any one of paragraphs G-O, wherein the text data represents a natural language prompt corresponding to the logic condition, the one or more processors further to: apply the text data as an input prompt to one or more second language models; and obtain, based at least on the one or more second language models processing the text data and state data representing the state of the interactive application, output data indicating that the alert condition is satisfied, wherein the determination that the alert condition is satisfied is based at least on the output data.
Q. The system of any one of paragraphs G-P, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system that incorporates one or more machine learning models deployed in a service or microservice along with an OS-level virtualization package; a system implemented at least partially in a data center; or a system implemented at least partially using cloud computing resources.
R. One or more processors comprising processing circuitry to: generate, using one or more language models to process input data representing a natural language request to issue an alert responsive to occurrence of an event associated with an interactive application, text data representing one or more logic conditions for evaluating one or more states of the interactive application during runtime to determine whether to cause output of the alert within a graphical user interface associated with the interactive application.
S. The one or more processors of paragraph R, wherein the input data further represents contextual information corresponding to the interactive application, the contextual information obtained from one or more vector databases associated with the interactive application.
T. The one or more processors of any one of paragraphs R-S, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system that incorporates one or more machine learning models deployed in a service or microservice along with an OS-level virtualization package; a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including handheld devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
obtaining input data representing at least one natural language expression of a user associated with an interactive application, the at least one natural language expression indicating one or more requests to issue one or more alerts responsive to one or more events associated with the interactive application;
generating, based at least on processing the input data using one or more language models, text data corresponding to one or more logic conditions related to issuing the one or more alerts;
determining, based at least on evaluating the one or more logic conditions with respect to state data representing one or more states of the interactive application, that the one or more events have occurred; and
based at least on the one or more events having occurred, causing output of the one or more alerts.

2. The method of claim 1, wherein the text data represents one or more data structures corresponding to the one or more logic conditions, the one or more data structures including at least one or more identifiers of one or more state keys, one or more threshold values, and one or more comparison operators.

3. The method of claim 1, wherein the text data represents code corresponding to the one or more logic conditions, the code including one or more functions to determine whether the one or more events have occurred based at least on evaluating one or more state key values indicative of the one or more states of the interactive application.

4. The method of claim 3, wherein the code comprises one or more functions, the method further comprising:
compiling the code into one or more dynamically loadable libraries; and
executing, during runtime of the interactive application, at least one of the one or more functions from the one or more dynamically loadable libraries to evaluate whether the one or more events have occurred.

5. The method of claim 1, wherein the text data represents a natural language prompt corresponding to the one or more logic conditions, the method further comprising:
applying the text data as an input prompt to one or more second language models; and
obtaining, based at least on the one or more second language models processing the text data and the state data, output data indicating whether the one or more events have occurred,
wherein the determining that the one or more events have occurred is based at least on the output data.

6. The method of claim 1, further comprising:
obtaining, from one or more vector databases associated with the interactive application, data representing contextual information corresponding to the interactive application,
wherein the generating of the text data using the one or more language models is further based at least on the one or more language models processing the data representing the contextual information.

7. A system comprising one or more processors to:
generate, using one or more language models and based at least on input data representing at least one natural language expression of a user associated with an interactive application, text data corresponding to a logic condition for evaluating an alert condition indicated by the at least one natural language expression;
determine that the alert condition is satisfied based at least on evaluating a state of the interactive application using the logic condition; and
cause, during runtime of the interactive application, output of an indication that the alert condition is satisfied.

8. The system of claim 7, wherein the text data represents a data structure corresponding to the logic condition, the data structure including at least an identifier of a state key, a threshold value, and a comparison operator.

9. The system of claim 8, wherein the evaluating the state of the interactive application comprises:
obtaining state data representing key-value pairs indicative of the state of the interactive application, the key-value pairs including the state key; and
evaluating, using the comparison operator, a value of the state key with respect to the threshold value.

10. The system of claim 7, wherein the text data represents code corresponding to the logic condition, the code including a function to determine whether the alert condition is satisfied based at least on evaluating one or more state key values associated with the state of the interactive application.

11. The system of claim 10, the one or more processors further to:
compile the code into a dynamically loadable library; and
execute, during runtime of the interactive application, the function from the dynamically loadable library.

12. The system of claim 7, the one or more processors further to:
obtain, from a vector database associated with the interactive application, data representing contextual information corresponding to the interactive application,
wherein the generation of the text data using the one or more language models is further based at least on the one or more language models processing the data representing the contextual information.

13. The system of claim 7, wherein causing the output of the indication comprises rendering, within a graphical user interface associated with the interactive application, one or more visual indications that the alert condition is satisfied.

14. The system of claim 7, wherein the evaluating the state of the interactive application using the logic condition comprises:
evaluating, at a first time, one or more first values of one or more state variables representative of the state of the interactive application; and
evaluating, at a second time after the first time, one or more second values of the one or more state variables.

15. The system of claim 14, wherein:
the first time corresponds to a first session of the interactive application, and
the second time corresponds to a second session of the interactive application.

16. The system of claim 7, wherein the text data represents a natural language prompt corresponding to the logic condition, the one or more processors further to:
apply the text data as an input prompt to one or more second language models; and
obtain, based at least on the one or more second language models processing the text data and state data representing the state of the interactive application, output data indicating that the alert condition is satisfied,
wherein the determination that the alert condition is satisfied is based at least on the output data.

17. The system of claim 7, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

18. One or more processors comprising processing circuitry to:
generate, using one or more language models to process input data representing a natural language request to issue an alert responsive to occurrence of an event associated with an interactive application, text data representing one or more logic conditions for evaluating one or more states of the interactive application during runtime to determine whether to cause output of the alert within a graphical user interface associated with the interactive application.

19. The one or more processors of claim 18, wherein the input data further represents contextual information corresponding to the interactive application, the contextual information obtained from one or more vector databases associated with the interactive application.

20. The one or more processors of claim 18, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.
